(19) United States
(12) Patent Application Publication
(10) Pub. No.: US 2019/0045022 A1
(43) Pub. Date: Feb. 7, 2019

(54) EDGE CACHING NODE FOR REMOTE CLOUD STORAGE SERVICE

(71) Applicant: Intel Corporation, Santa Clara, CA (US)

(72) Inventors: Francesc GUIM BERNAT, Barcelona (ES); Eoin WALSH, Shannon (IE); Paul MANNION, Ennis (IE); Timothy VERRALL, Pleasant Hill, CA (US); Mark A. SCHMISSEUR, Phoenix, AZ (US)

(21) Appl. No.: 15/940,958

(22) Filed: Mar. 29, 2018

(51) Int. Cl. H04L 29/08; H04L 29/06

(52) U.S. Cl. CPC H04L 67/2842; H04L 69/04; H04L 69/22; H04L 67/1097

(57) ABSTRACT

An apparatus is described. The apparatus includes switch circuitry to route packets that are destined for one or more cloud storage services instead to local caching resources. The packets are sent from different tenants of the one or more cloud storage services and have respective payloads that contain read/write commands for one or more cloud storage services. The apparatus includes storage controller circuitry to be coupled to non volatile memory. The non volatile memory is to implement the local caching resources. The storage controller is to implement customized caching treatment for the different tenants. The apparatus includes network interface circuitry coupled between the switch circuitry and the storage controller circuitry to implement customized network end point processing for the different tenants.

### FIELD OF INVENTION

The field of invention pertains generally to the information management sciences, and, more specifically, to an edge caching node for remote cloud storage service.

### BACKGROUND

With various large scale functions being migrated to the cloud, points of congestion can arise in the infrastructure deployment that carries information between the cloud and the client devices that use the cloud. As such, information systems managers are looking for new technologies that can alleviate the congestion and/or otherwise reduce any propagation delays stemming from the funneling of large amounts of information to the cloud interface.

### FIGURES

A better understanding of the present invention can be obtained from the following detailed description in conjunction with the following drawings, in which:

FIG. 1 shows an exemplary information systems deployment;

FIG. 2 shows an improved exemplary information systems deployment;

FIG. 3 shows a node of the improved information systems deployment of FIG. 2;

FIG. 4 shows a method of the node of FIG. 3.

### DETAILED DESCRIPTION

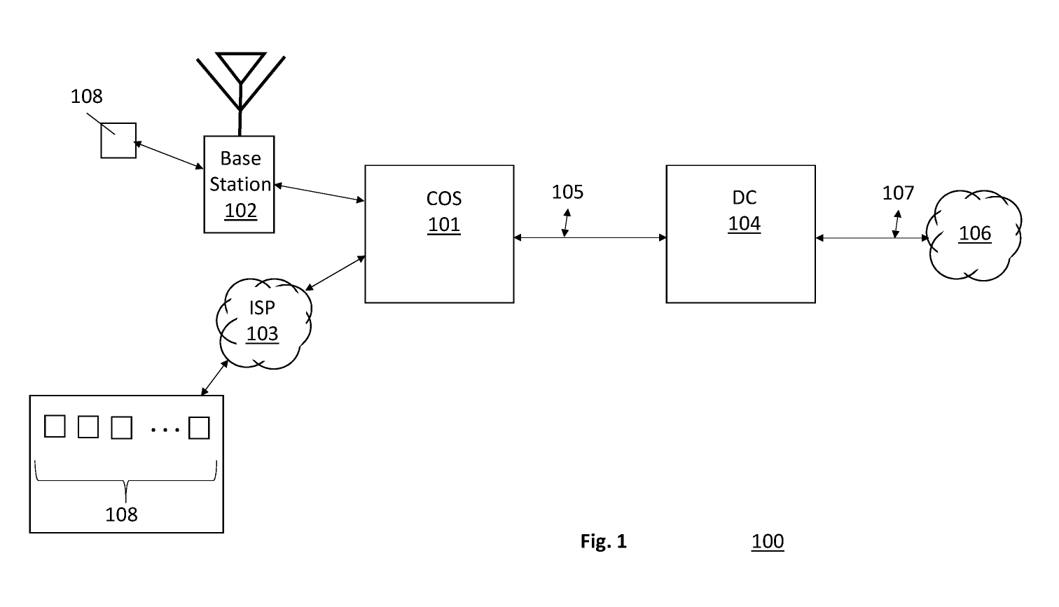

FIG. 1 shows an information systems (IS) deployment 100 that is common to large entities such as large corporations and/or large government entities. As observed in FIG. 1, a central office switch 101 acts as a gateway between more regional/local networking infrastructure (e.g., a base station 102, local internet service provider 103, etc.) and the entity's data center 104. Here, not uncommonly, one or more high speed trunk lines 105 carry data traffic between the central office switch 101 and the data center 104 over a long geographic distance that separates the central office switch 101 and the data center 104.

The data center 104, in turn, relies upon a cloud service 106 for one or more IS services (e.g., cloud computing, cloud storage, etc.). Again, not uncommonly, a large geographic distance may separate the entity's data center 104 from the cloud service 106 and one or more high speed trunk lines 107 may couple the data/transaction flow between the data center 104 and the cloud service 106.

One of the more popular cloud services is cloud storage. Here, various client devices 108 (e.g., mobile devices (e.g., smartphones, laptop computers) and/or desktop computers, tower computers, etc.) access data that is stored by the cloud service 106. As a consequence, potentially, large amounts of data traffic are transported over the trunk line 105 between the cloud service 106 and the data center 104 and/or the trunk line 107 between the data center 104 and the central office 101. In a worst case scenario, the aggregate storage needs (in terms of data) of all client devices 108 passes through both of these connections 105, 107.

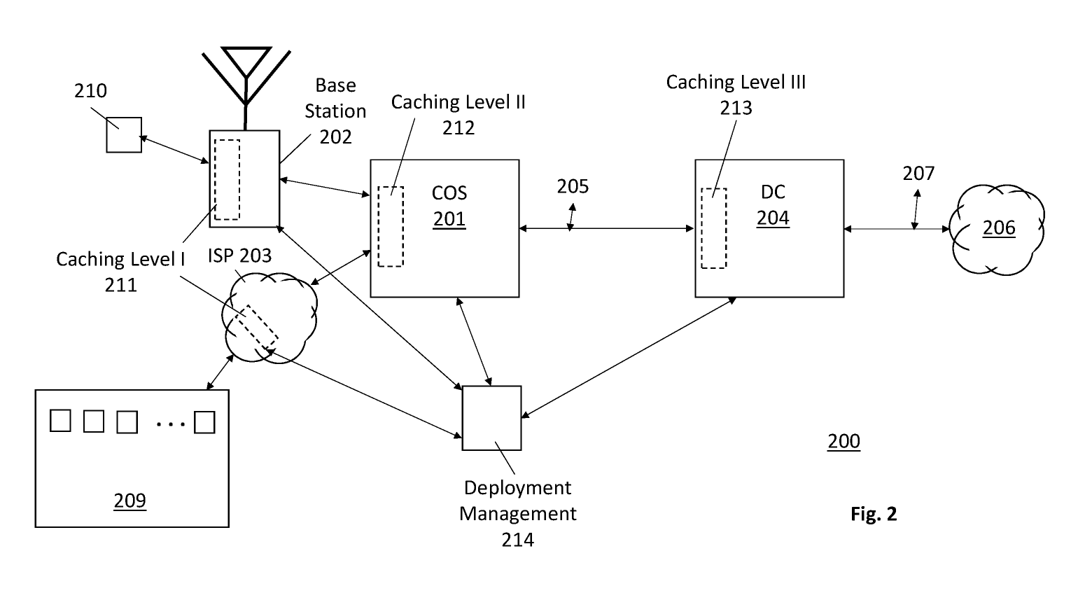

IS managers have therefore been highly motivated to integrate tiered caching levels across the different nodes of the deployment of FIG. 1. Here, referring to FIG. 2, each major node of the deployment leading up to the cloud storage service (the base station, the office gateway, the central office switch and the data center) is observed to include a caching level. The caching levels 211, 212, 213 are supposed to keep more frequently requested items of data to offload traffic pressure to/from the cloud storage service 206. With the tiered caching levels 211, 212, 213, ideally, client read/write requests for data that is “formally” kept by the cloud storage service 206 do not have to transverse the entire deployment “back” to the cloud service 206.

Instead, for instance, if a item of data that is needed by a client 208 is cached at the central office switch's cache 212, the request need only travel from the client device 208 to the central office switch 201 from where the request can be fully serviced. The backbone trunk lines 205, 207, as well as the data center 204 and cloud service 206 themselves, therefore, do not participate in the handling or servicing of the request.

As such, the presence of tiered caching greatly diminishes the traffic handled by the backbone and/or back-ends of the deployment, which, in turn, greatly improves the efficiency of the overall system. Such improvements may include improved response times for requests that are serviced by a cache (because the request/response cycles travel less geographic distance and/or experience less overall queuing delay), and/or, improved responses times for requests that are ultimately serviced by the cloud service (because the back end of the deployment processes/carries less overall traffic as consequence of the caching).

A problem however is the granularity at which the caching levels 211, 212, 213 cache their respective items of data. Here, for instance, a larger client entity may “swamp out” the caching needs of a smaller client entity. For instance, referring to FIG. 2, if the central office switch 202 simply caches the data that is most frequently accessed from its own perspective, the cache contents will tend to be most responsive to the requests submitted by a larger office building 209 rather than a single smartphone user 210.

Here, the office building 209 is apt to have hundreds if not thousands of client systems requesting data. To the extent these client systems are requesting same/similar items of data, such data will be cached by the central office's cache 212 at the expense of the smartphone's caching needs which only generates singular requests for any specific item and not aggregated requests as with the office building 209.

As such, it is altogether possible that little/no caching resources are leftover for the single mobile user 210 who must have its requests satisfied deeper into the deployment (e.g, the data center cache 213) if not all the way back to the cloud 206. This can be problematic not only from a fairness or quality of service perspective (the singular mobile device 210 is not able to enjoy any speed-up from the central office cache 212), but may also bring the performance of the overall deployment farther away from optimum efficiency. For instance, if the single mobile device requires a high bandwidth read-only video stream, whereas many of the office location's requests are simple requests for small items of data, perhaps a disproportionate share of response data is transported/processed by the back end trunks 205, 207 data center 204 and/or cloud service 206 by refusing the mobile device 210 cache service.

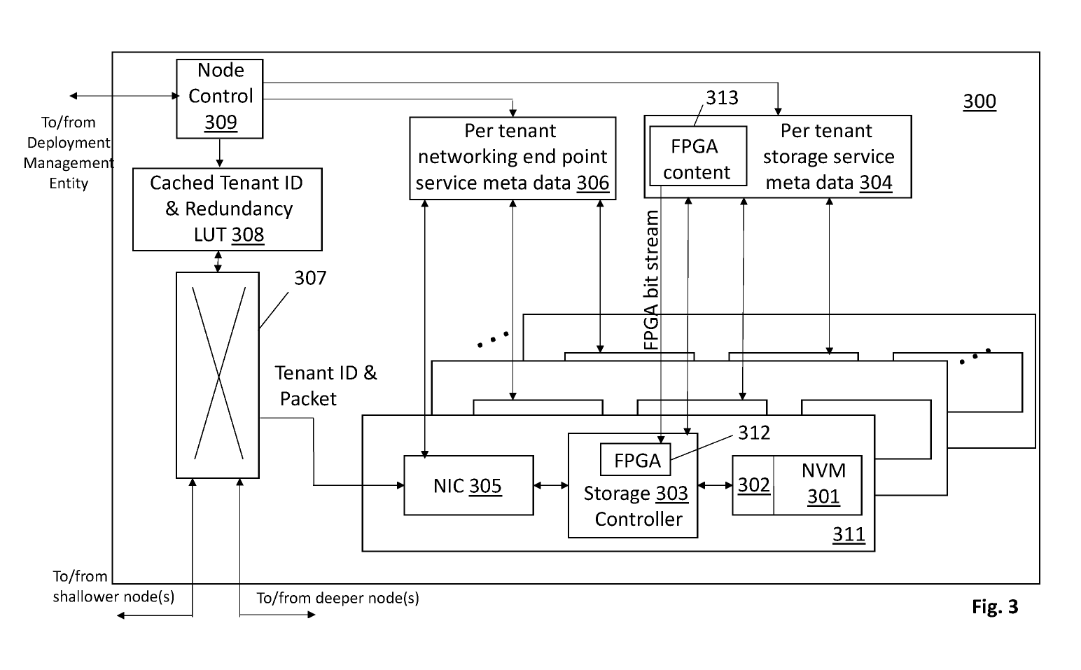

FIG. 3 shows an architecture 300 for an improved network node design that can be placed at any of the major deployment nodes 201, 202, 203, 204 of FIG. 2. Importantly, the node design 300 is designed to provide “per tenant” caching treatment. Here, a tenant is some quanta on the client-side that issues requests for data and/or to whom responses to such requests are sent. In basic embodiments a tenant corresponds to a client device, and/or, any particular instance of software that executes on a client device. For example, two different software applications running on a same computer may be regarded as different tenants each having their own dedicated quality of service treatment as applied by the caching layer that is implemented at the node.

As observed in FIG. 3, the architecture 300 includes memory resources 301 for keeping cached data items. Here, the memory resources 301 allow the node to physically cache data. In various embodiments, the memory resources 301 include emerging non volatile memory technology.

Emerging non volatile memory chips are often characterized as being resistive in nature (the storage cells record different logic levels by maintaining different resistance values), having write and/or read access times that are faster than traditional flash non volatile semiconductor memory, and/or, can access their data at finer granularities than flash non volatile semiconductor memory (e.g., while flash is traditionally accessed only at larger block or sector granularities, by contrast, emerging non volatile memories can be accessed at cache line granularity and/or are byte addressable (e.g., write operations can be performed with a write data size that is only one byte). Another possible advantage over traditional flash non volatile memory is the integration of the storage cells in the wiring metallurgy/dielectric that resides above the semiconductor substrate rather than embedding the storage cells in the semiconductor substrate (as with DRAM). Here, if the storage cells are manufactured in the wiring metallurgy/dielectric above the semiconductor substrate, three dimensional arrays of storage cells can be formed above the substrate (e.g., by stacking cells over one another). With three-dimensional storage structures, very high storage densities may be achieved which, in turn, can result in very large caching storage space being realized at each node in the deployment.

Examples of such emerging non volatile memory may include a phase change based memory, a three dimensional crosspoint memory, “write-in-place” non volatile main memory devices, memory devices having storage cells composed of chalcogenide, a ferro-electric based memory (e.g., FRAM), a magnetic based memory (e.g., MRAM), a spin transfer torque based memory (e.g., STT-RAM), a resistor based memory (e.g., ReRAM), a Memristor based memory, universal memory, Ge2Sb2Te5 memory, programmable metallization cell memory, amorphous cell memory, Ovshinsky memory, etc.

The non volatile memory 301 may also, conceivably, be implemented with flash memory (albeit while sacrificing potential advantages of emerging non volatile memory as described above). Regardless of the precise nature of the non volatile memory that is used to implement the caching memory 301, the non volatile memory 301 may be locally front-ended with a faster, e.g., DRAM, cache 302 to speed up the observed performance of the non volatile memory.

Importantly, the non volatile memory space has a dedicated storage controller 303 that is responsible for managing customized storage treatment on a per tenant basis. For instance, the storage controller 303 may refer to a set of tenant IDs and corresponding meta data 304 for each tenant ID that describes the caching service for the particular tenant.

Examples of such meta data parameters include: 1) amount of caching resources in the non volatile memory 301 that has been allocated for the tenant (e.g., in MB or GB); 2) the address space range in the non volatile memory 301 that is allocated for the tenant (the allocated address space range should be consistent with the amount of memory space that have been allocated to the tenant); 3) whether local (e.g., DRAM) caching 302 is to be applied for the tenant; 4) whether compression/decompression is to be applied to the tenant's data; 5) whether encryption/decryption is to be applied to the tenant's data; 5) a priority level of the tenant's data (e.g., video stream data may have a higher priority level than nominal data); 6) a file/storage service accessing protocol (e.g., Network File System (NFS), New Technology File System (NTFS), Amazon S3),etc.

As depicted in FIG. 3, the meta data 304 is kept in local memory 304 (e.g., a content addressable memory) that is accessible to the storage controller 303. When processing a read or write request for a particular cached tenant, in an embodiment, the storage controller 303 applies a tenant ID to the local memory 304 to retrieve the set of meta data parameters that define the appropriate caching treatment for the tenant. Note that the storage controller may include functionality (e.g., software/firmware) designed to mimic one or more cloud storage services that a client ultimately directs it read/write requests to (e.g., Amazon S3). That is, for example, the storage controller 303 is programmed with functional logic that prepares responses according to the Amazon S3 storage protocol and/or any other kind of cloud storage protocol so that the client “thinks” it is communicating to the actual service in the cloud 206 rather than a shallower node in the deployment (such as the central office switch 201).

In still yet other embodiments, the storage controller 303 implements customized cache eviction policies for each tenant. That is, the storage controller 303 determines which items that are stored in the allocated storage space for each particular tenant are to be evicted from the local cache, and, e.g., moved to a next lower cache (e.g., the cache of a next deeper node in the deployment).

Here, in various embodiments, the storage controller 303 implements any of its aforementioned functions (e.g., file/storage service accessing protocol, cloud storage service protocol mimic-ing, cache eviction policies, etc.) with programmable logic circuitry (e.g., field programmable gate array (FPGA) logic circuitry 312) so as to effectively accelerate these functions as compared to an approach that implements these functions in software/firmware by a processor.

Here, the logic information 313 for each of the individual functions that the storage controller 303 can accelerate with the FPGA 312 are stored as a special type of meta data 304 that is accessed by the storage controller 303. During configuration of each tenant, the FPGA 312 is programmed with a subset of the information 313 that corresponds to the specific FPGA accelerated function to be implemented for the tenant (the selected subset of information is passed as a bit steam to the storage controller 303 and programmed into the FPGA). Here, the FPGA information 313 may include the logic for many different types of functions so that the storage controller has a large menu of possible functions that can be FPGA accelerated for any/all tenants.

As depicted in FIG. 3, the node 300 includes a switch 307 that is coupled to the appropriate, different nodes in the deployment. For instance, if the node 303 of FIG. 3 corresponds to the central office switch 201, the switch 307 is coupled to the base station 202 and local Internet Service Provider (ISP) 203 on the front or shallower end, and, is coupled to the trunk line(s) 205 that are coupled to the data center 204 on the back or deeper end. Here, the switch 307 can be seen as an integral part of the central office switch 201 itself (which is primarily responsible for receiving packets from the local clients and directing them toward the data center or to other local clients depending on destination address). The switch may be implemented as a switch and/or router. For simplicity, the term “switch” will be applied more generally to mean switch and/or router.

In an embodiment, the switch 307 is configured to recognize which incoming packets received from the front end are to receive caching treatment at the node 300 and which fof these packets are not to receive caching treatment at the node 300. Here, again, if node 300 corresponds to the central office switch 201, inbound packets from the mobile device 210 or office building 209 that are not to receive caching treatment at the central office switch node 300 are forwarded by the switch 309 to the outbound trunks 205 for transportation to the data center 204. The inbound packets from the mobile device 210 or office building 209 that are to receiving caching treatment at the central office switch node 300 are forwarded by the switch 309 to a network interface 305 of the node 300 for end-point processing.

Here, each of the inbound packets that are handled by the switch 307 include header information that identify not only destination address (e.g., the cloud storage service in the cloud 206 that is packet is directed to) but also the sender. Here, the sender may be identified with an Internet Protocol (IP) and/or media access control (MAC) address of the client device that sent the request packet. If multiple tenants exist per client device (e.g., different software applications on different client devices are treated as different tenants), the sending tenant may be further identified with higher level information within the packet header structure such as a transmission flow control (TCP) address. Here, different software applications within a same client device may have a same IP address (that of the client device) but different TCP addresses.

Regardless, by processing the aforementioned header information on inbound packets, the switch 307 can quickly discern whether an inbound packet is to be treated with caching services at the node 300 or is to be forwarded to the next deeper node in the deployment. More specifically, in an embodiment, the switch 307 keeps a look-up table 308 (e.g., implemented with memory such as a content addressable memory) that identifies the packet header information of sending tenants that are to receive caching treatment at the node 300. Those incoming packets from local clients having sender header information that matches the entries on the look-up table 304 are identified as packets that are to receive caching treatment at the node 300 and are forwarded to the network interface 305, while, those incoming packets having sender header information that do not match the entries on the look-up table 304 are identified as packets that are not to receive caching treatment at the node 300 and are forwarded to the next deeper node in the deployment (e.g., the data center).

In a further embodiment, in the case where the sender header information corresponds to that of a tenant that is to receive caching treatment at the node 300, the look-up process into the look up table 304 also returns a tenant_ID that is appended to the packet and forwarded to the networking interface bank 305. Note also that destination information in the packet header can be used to identify the specific service in the cloud 206 that the request pertains to. Thus, in various embodiments, not only sender but also destination information is used to identify the tenant_ID. Here, for instance, a same tenant may use two different services in the cloud 206. The destination information is useable to distinguish between the two and assign two different tenant_IDs for a same tenant for the two different services.

The network interface 305 performs the network end point processing that the tenant expects from the destination it is sending to. For instance, if the tenant is configured to write/read data to/from the cloud service according to a specific type of network connection (e.g., a particular Transmission Control Protocol (TCP) version), the network interface processes the request packet from the tenant according to the particulars of the specific network connection type.

Other than implementing flow control according to a particular flow control protocol that the tenant expects, the networking interface 305 may also perform secure connection processes to, e.g., ensure that the request packet was actually sent by the tenant and not an imposter of the tenant. Here, as is known in the art, connections can be deemed secure if the sending entity is able to verify itself by, e.g., providing authenticating credentials when expected or when asked according to the secure authentication process performed by the end point. Here, again, the network interface 305 performs the destination end point authentication process for the tenant's communication and/or any communication related encryption/decryption processes in support thereof. Note that such processes may be very tenant specific. For instance, different tenants may have different secure identifications, may encrypt/decrypt communications with the end point according to a specific encryption/decryption processes, etc.

As such, as with the storage controller 303, the network interface 305 also relies on some form of meta data 306 that defines how communication with the tenant is to be transacted. Such tenant specific meta data 306 may include, for instance: 1) a specific flow control protocol used by the tenant (e.g., TCP, Real Time Streaming Control Protocol (RTSP), Real Time Transport Protocol (RTP), Real Time Control Protocol (RTCP), Hyper Text Transport Protocol (HTTP), a proprietary flow control protocol, etc.); 2) a specific secure communication protocol (e.g., Hyper Text Transfer Protocol Secure (HTTPS), Transport Layer Security (TLS), Secure Sockets Layer (SSL), Secure File Transfer Protocol (SFTP), etc.); 3) authentication details of the tenant. The meta data may also be kept in memory (e.g., content addressable memory) 306 that is local to the network interface 305. The tenant_ID may be used as a look up into the meta data 306.

Ultimately, after processing by the network interface 305 is completed for the inbound packet, the payload of the original packet, which nominally includes the actual request by the tenant and the aforementioned tenant_ID, is forwarded to the storage controller 303.

In an embodiment, the storage controller 303 also uses the tenant ID to look-up the storage meta data 304 for the specific tenant and processes the request packet's request according to the treatment specified in the storage meta data 304. In the case of a basic storage request, the request typically specifies whether the request is a write operation or a read operation. The request also includes an address, object ID, or filepath directory location that uniquely identifies the item to be read or written to that is formatted according to the specific protocol of the cloud storage service that the client technically sent the request to.

In the case of a write operation the request also includes new data that is to be written into the item. An acknowledgement or confirmation of a successful write that is formatted consistently with the protocol of the deeper cloud storage service may be generated by the storage controller 303 and forwarded to the network interface 305 which encapsulates the acknowledgement with the correct end-point header information for the particular connection. The encapsulated acknowledgement and tenant_ID may then be forwarded to the switch 307 which performs a reverse look-up on the tenant_ID to extract and encapsulate the sender information as destination information for the packet. The switch 307 then physically routes the outbound packet back to the sender along an egress line that is coupled to a shallower node. In the case of read operation, the same process is followed except that the acknowledgement payload also includes the requested read information.

In various embodiments, in the inbound direction, the switch's look-up 308 also recognizes any applicable redundancy treatment for any particular tenant and manipulates the data stream in response. In particular, certain cloud storage providers have different quality of service levels with respect to loss of data and/or availability, where, each quality of service level generally corresponds to a respective amount of redundancy. For example, greater guarantees against data loss and against unavailability are generally implemented with greater degrees of redundancy (more instances of the same data item are stored) while lesser guarantees against data loss and against unavailability are generally implemented with lesser degrees of redundancy (fewer instances of the same data item are stored).

Here, for any inbound write operation to be applied to an existing data item or new data item to be cached at the node 300, the switch's look-up 308 also returns how many redundant copies of the data item are to be written to/instantiated. The switch 307 then physically duplicates the request (e.g., by making multiple copies thereof) and directs them, e.g., to different network interface circuits.

Here, as observed in FIG. 3, the overall caching structure is scalable in that more than one “channel” 311 of network interface 305, storage controller 303 and caching memory 301 may reside at the node. Here, for instance, each “channel” may correspond to an entire computing system, a blade/card within a computing system, discrete units on a same blade/card etc. Regardless, the overall architecture is highly scalable. Redundancy may be implemented, e.g., by storing different instances of a same cached item in different channels. Thus, if the switch look-up 308 reveals that multiple instances of a same cached item are to be replicated, the switch directs multiple copies of the same packet to the different respective network interfaces of the different channels in which the various replicas of the data item will be stored.

The different network interfaces concurrently process their respective requests and forward their resultant to the corresponding storage controller in their respective channel. The different channels then each store their data replications in the combined memory resources of the channels. Here, each tenant_ID may have a replica extension (e.g., tenant_ID.rep) where each increment in replica extension corresponds to an additional level of replication.

Replication of incoming packets at the switch 307 also provides for replication across different caching tiers. Thus, for instance, the switch 307 may replicate an incoming request into two identical requests, send one of the requests to a local network interface 305 within the instant node 300, and, e.g., send the other of the requests to a next, deeper node with caching (e.g., from the central office switch caching tier to the data center caching tier).

In an alternative embodiment, replicas are not generated at the switch but instead are generated at the storage controller 303. That is, replica generation may be entirely handled in the storage controller in which case only one network interface 305 is invoked per session regardless of the amount of replication. Further still, other embodiments may include replication both at the switch and at the storage controller for a single tenant. In replication scenarios where more than one network interface 305 and/or storage controller 303 is used to effect replication, a primary network interfaces 305 and/or storage controller 303 is chosen to actually craft communication responses back to the tenant (responses by the other network interfaces and/or storage controllers is squelched and/or disabled).

With the above description of basic traffic flows in mind, it is pertinent to recognize that the overall dataflow path includes per tenant customized information, e.g., at each major function in the data path. Specifically, as discussed above: 1) the storage resources include a storage controller 303 that relies upon customized per tenant meta data 304 to apply proper storage request treatment for each particular tenant; 2) the switch 307 is programmed with a look-up table 308 having, e.g., per tenant entries to uniquely identify the tenant for each incoming packet and/or define what replication is to be uniquely applied to the tenant's incoming packet; and, 3) the network interface 305 relies upon per tenant meta data 306 to inform the network interface 305, e.g., what transport layer protocol is to be used for the tenant, what secure connection technology is to be used for the tenant, etc.

As such, in the node architecture 300 of FIG. 3, each of these look-up stores 304, 306, 308 are designed to be programmed with information from a node controller 309. Here, the node controller 309 is responsible for building the meta data set 304, 306, 308 for each tenant in a data store resource (e.g., local memory) of the storage controller 303 which the storage controller accesses in order to provide customized per tenant storage treatment. Likewise, the node controller 309 is also responsible for building the per tenant content in the switch's look-up table 308. Finally, the node controller 309 is responsible for building the meta data set 306 for each tenant in a data store resource (e.g., local memory) of the network interface 305 which the network interface accesses in order to provide customized per tenant end point network connection treatment.

In various embodiments, the node controller 309 receives information from a management entity 214 of the deployment that defines the specific treatment for each tenant (replication, transport/security protocols, storage treatment, etc.). The node control function 309 assigns a tenant_ID for each tenant and programs the storage controller 303, switch 307 and network interface 305 look-up meta data 304, 308, 306 with the information to effectively configure/program these functions to process each tenant's requests correctly.

The controller may also collect statistics on the activity of the different tenants it is caching and, e.g., report them back to the management entity 214. Statistics can include various measurements of how frequently or infrequently cached items for a particular tenant are being cached. In response, the management entity 214 may choose to move cached items for certain tenants up or down in the deployment. For example, a tenant whose data items are being cached at the central office switch 201 but whose statistics reveal relatively less frequent access, may have the data items migrated back to the caching resources of the data center 204. Likewise, a tenant whose data items being cached at the data center 204 but whose statistics reveal relatively more frequent access, may the data items migrated up to the caching resources of the central office switch 201. Such caching policy implementation may be performed along with or in-lieu of any caching policy management applied by the storage controller 303 (such as FPGA accelerate caching policy management described above with respect to FIG. 3).

In various embodiments, data items that are private to particular tenant or read only data items that can be accessed by more than one tenant are free to moved (e.g., “up”) to nodes in the deployment that do not observe all accesses to the cloud service 206. For instance, any read only data item or any data item that is solely a tenant of device 210 may be migrated all the way up to the caching level of the base station 202. For consistency reasons, items of data that can be written to by multiple tenants/devices, in various embodiments, are only migrated up to the caching resources of a node that can observe all accesses to the data item.

For example, in an embodiment, a data item that is writeable by both device 210 and any client of the office building 209 is only permitted to be migrated as far up as the central office switch 201 because the central office switch 201 is the highest level node in the deployment that will observe all accesses to the data item.

In a further functional extension of the switch 307, the switch's look-up table 308 and associated logic may be configured to: 1) understand which different tenants have write access to a particular data item; 2) the addresses used for each tenant specific instance of the data item stored in its caching resources; 3) detect a write operation to one of these instances by one of the tenants (by analyzing the packet payload against the information of 2) above); 4) replicate the write operation to all tenant specific instances of the data item (combined with any additional replications owing to specific redundancy treatment for any of the tenants).

Alternatively, in order to preserve storage resources, the switch's look-up table 308 and logic, may instead consolidate the number of instances so that each of the different tenants are directed to use the same primary instance in the caching resources, e.g., the instance of just one of the tenants. Here, the look-up table “swaps” or “flips” tenant IDs so that a write request for all tenants that have write access to the data item are swapped to the tenant ID whose is deemed to be the keeper of the primary data item (reads are similarly handled). Each write request may also be duplicated as appropriate (e.g., the primary tenant is the tenant that requires the most redundancy/replication amongst the tenants that have write access to the same data item). In this manner one data item is collectively used for all of the tenants.

In the embodiments described above, the node 300 may be partially or wholly integrated on one or more semiconductor chips. To the extent semiconductor manufacturing uses incompatible processes for, e.g., the memory and the functional logic, such logic and memory may be disposed on different semiconductor chips. In the case where more than one semiconductor chip is used to implement the different logic functions of the node 300, a multitude of different possible combinations exist (e.g., a single semiconductor chip is used for one of the channels 311, a single semiconductor chip is used for multiple channels 311, a semiconductor chip having one or more logical functions of a channel also includes some or all logic of the switch 307 and/or controller 309, etc.

With respect to implementation of the logic specifically, any of the logic described above may be implemented with various forms of logic circuitry including custom hardwired logic circuitry, programmable logic circuitry (e.g., field programmable gate array (FPGA), programmable logic device (PLD), programmable logic array, etc.), or logic circuitry that executes some form of program code (e.g., a general purpose processor, an embedded processor, an embedded controller, a digital signal processor, etc.). Although the FIG. 3 does not depict and specific processors, one or more processors may be coupled to any one or more of the major logic blocks 303, 305, 307, 309 to, e.g., more cost effectively implement any of their functions (so that they are performed through execution of program code).

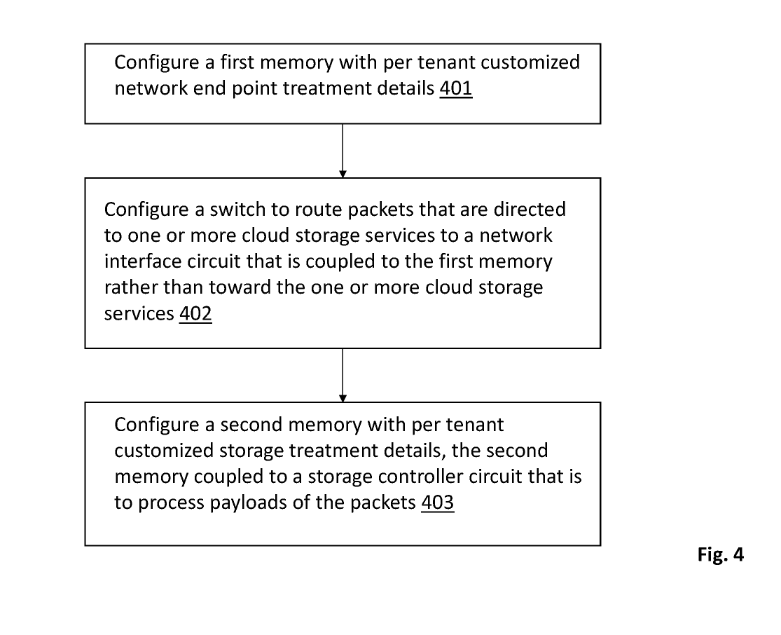

FIG. 4 shows a method described above. The method includes configuring a first memory with per tenant customized network end point treatment details 401. The method includes configuring a switch to route packets that are directed to one or more cloud storage services to a network interface circuit that is coupled to the first memory rather than toward the one or more cloud storage services 402. The method includes configuring a second memory with per tenant customized storage treatment details, the second memory coupled to a storage controller circuit that is to process payloads of the packets 403.

Embodiments of the invention may include various processes as set forth above. The processes may be embodied in machine-executable instructions. The instructions can be used to cause a general-purpose or special-purpose processor to perform certain processes. Alternatively, these processes may be performed by specific/custom hardware components that contain hardwired logic circuitry or programmable logic circuitry (e.g., FPGA, PLD) for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed:

1. An apparatus, comprising:
switch circuitry to route packets that are destined for one or more cloud storage services instead to local caching resources, the packets sent from different tenants of the one or more cloud storage services and having respective payloads that contain read/write commands for one or more cloud storage services;
storage controller circuitry to be coupled to non volatile memory, the non volatile memory to implement the local caching resources, the storage controller to implement customized caching treatment for the different tenants;
network interface circuitry coupled between the switch circuitry and the storage controller circuitry to implement customized network end point processing for the different tenants.

2. The apparatus of claim 1 wherein the switch circuitry is further to replicate those of the packets whose data items are replicated in order to implement one or more reliability and/or availability guarantees by the one or more cloud storage services that the packets are directed to.

3. The apparatus of claim 1 wherein the switch circuitry is to be coupled to a memory having meta data that correlates header information of the packets to corresponding tenant identifiers.

4. The apparatus of claim 3 wherein the memory further identifies replication treatment for specific ones of the tenants.

5. The apparatus of claim 1 wherein the storage controller circuitry is to be coupled to a memory having meta data that describes customized per tenant caching details.

6. The apparatus of claim 5 wherein the customized per tenant caching details includes at least one of:
whether compression/decompression is to be applied for a particular tenant's data;
a particular storage protocol to be applied to the particular tenant's data;
an address range within the non volatile memory within which the particular tenant's data is to be written.

7. The apparatus of claim 1 wherein the network interface circuitry is to be coupled to memory having meta data that describes customized per tenant network connection end-point details.

8. The apparatus of claim 7 wherein the customized per tenant network connection end-pointed details include at least one of:
a particular transport layer protocol to be applied to a particular tenant's packets;
a particular security protocol to be applied to a particular tenant's packets;
authentication details for a particular tenant's packets.

9. The apparatus of claim 1 further comprising control logic circuitry to configure each of the switch circuitry, storage controller circuitry and network interface circuitry with customized per tenant information.

10. The apparatus of claim 1 wherein the storage controller circuitry includes programmable logic circuitry to accelerate any of:
per tenant caching policies;
per tenant storage service protocols.

11. An information systems deployment, comprising:
a data center that is coupled to one or more cloud storage services;
a node that is coupled to the data center, the node to receive packets that are directed to the one or more cloud storage services and sent by different tenants, wherein, both the node and the data center include respective caches for the one or more cloud storage services, the respective caches implemented with a respective:
switch circuit to route a respective subset of the packets instead to local caching resources;
non volatile memory, the non volatile memory to implement the local caching resources;
storage controller circuit that is coupled to non volatile memory, the storage controller to implement customized caching treatment for the different tenants;
network interface circuit coupled between the switch circuitry and the storage controller circuit to implement customized network end point processing for the different tenants.

12. The information systems deployment of claim 11 wherein the switch circuit is further to replicate those of the packets whose data items are replicated in order to implement one or more reliability and/or availability guarantees by the one or more cloud storage services that the packets are directed to.

13. The information systems deployment of claim 11 wherein the switch circuit is coupled to a memory having meta data that correlates header information of the packets to corresponding tenant identifiers.

14. The information systems deployment of claim 11 wherein the storage controller circuit is coupled to a memory having meta data that describes customized per tenant caching details.

15. The information systems deployment of claim 11 wherein the network interface circuit is coupled to memory having meta data that describes customized per tenant network connection end-point details.

16. The information systems deployment of claim 1 wherein the respective caches are further implemented with a respective control logic circuit to configure each of the switch circuit, storage controller circuit and network interface circuit with customized per tenant information.

17. A method, comprising:
configuring a first memory with per tenant customized network end point treatment details;
configuring a switch to route packets that are directed to one or more cloud storage services to a network interface circuit that is coupled to the first memory rather than toward the one or more cloud storage services;
configuring a second memory with per tenant customized storage treatment details, the second memory coupled to a storage controller circuit that is to process payloads of the packets.

18. The method of claim 17 further comprising the storage controller circuit storing data found within at least some of the packets in non volatile memory.

19. The method of claim 17 further comprising the switch replicating a subset of the packets containing write data whose corresponding cloud storage service is configured to redundantly store the write data.

20. The method of claim 17 wherein the configuring of the first memory, switch and second memory is performed by a controller that receives customized per tenant details from a deployment management entity.
